(19) United States
(12) Patent Application Publication
(10) Pub. No.: US 2002/0154148 A1
(43) Pub. Date: Oct. 24, 2002

(54) Image displaying method

(76) Inventors: Aiichi Inoue, Tokyo (JP); Genichi Tanaka, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/950,618

(22) Filed: Sep. 13, 2001

(30) Foreign Application Priority Data
Apr. 20, 2001 (JP) 2001-123285

(51) Int. Cl. G09G 5/00

(52) U.S. Cl. 345/660

(57) ABSTRACT

An image zoomed-in area, in which an image planned to be zoomed in is displayed, is specified, shape data of a zoomed-in image area is calculated according to shape data of the image zoomed-in area, an arranging position of the zoomed-in image area in an image screen is determined, a remained area, which is obtained by removing the zoomed-in image area from the whole area of the image screen, is recognized, the image of the image zoomed-in area is zoomed in to display the zoomed-in image in the zoomed-in image area, and no image is displayed in the remained area. Therefore, the displaying processing for images of the remained area, for which no user carefully pay attention, can be omitted, and the image display of the zoomed-in image can be performed at high speed when the image zooming-in processing is performed to obtain the zoomed-in image.

### BACKGROUND OF THE INVENTION

1. Field of the Invention

The present invention relates to an image displaying method used for a computer aided design (CAD) system, and more particularly to an image displaying method in which objects are selected from various objects prepared by executing a graphic data processing program and images of the selected objects are displayed.

2. Description of Related Art

FIG. 11 is a view showing a change of a displayed image in cases where the image zooming-in processing is performed for the displayed image according to a conventional image displaying method. In FIG. 11, 101 indicates a whole image screen on which an image or a plurality of images not yet zoomed in are displayed. 102 indicates an image zoomed-in area in which a displayed image planned to be zoomed in is arranged. 103 indicates a zoomed-in image area in which a displayed image zoomed in according to the image zooming-in processing is arranged. 104 indicates a remained area. An area of the whole image screen 101 is composed of the zoomed-in image area 103 and the remained area 104.

Next, the image zooming-in processing performed according to a conventional image displaying method will be described below.

The image zoomed-in area 102 is set according to user's operation such as an area designation using a mouse or the inputting of coordinate values using a keyboard. When an area setting of the image zoomed-in area 102 is completed, the image zooming-in processing is performed for an image displayed in the image zoomed-in area 102. Thereafter, a zoomed-in image obtained according to the image zooming-in processing is displayed in the zoomed-in image area 103 placed at a prescribed position of the whole image screen 101. Also, when the image zooming-in processing is performed, remained images displayed in peripheral areas of the image zoomed-in area 102 before the image zooming-in process are zoomed in and displayed in the remained area 104, or the remained images are displayed in the remained area 104 without zooming in the remained images.

Therefore, when the image zooming-in processing is performed for the image displayed in the image zoomed-in area 102, the zoomed-in image is displayed in the zoomed-in image area 103, and the remained images positioned in the peripheral areas of the image zoomed-in area 102 are displayed in the remained area 104.

In this case, to display images of various objects, which are positioned in the peripheral areas of the image zoomed-in area 102, in the remained area 104 to which the user does not carefully pay attention, it is required to process the objects in addition to the processing for the image displayed in the image zoomed-in area 102. Therefore, a problem has arisen that it takes a long time to display the zoomed-in image in the zoomed-in image area 103.

Also, images displayed on the whole image screen 101 are changed each time an operation is performed for the images of the whole image screen 101. In this case, there is a specific area of the whole image screen 101 in which a user does not carefully pay attention to images. However, each time the images displayed on the whole image screen 101 are changed, it is required to process various objects of the specific area. Therefore, a problem has arisen that it takes a long time to display parts of the images in the specific area each time the images displayed on the whole image screen 101 are changed.

### SUMMARY OF THE INVENTION

A main object of the present invention is to provide, with due consideration to the drawbacks of the conventional image displaying method, an image displaying method in which an image display of a zoomed-in image is performed at high speed when the image zooming-in processing is performed to obtain the zoomed-in image.

Also, a subordinate object of the present invention is to provide an image displaying method in which a picture display is performed at high speed even though a displayed image is changed to another image in a normal operation.

The main object is achieved by the provision of an image displaying method comprising a step of specifying an image zoomed-in area of an image screen in which an image planned to be zoomed in according to a zooming-in processing is displayed, a step of calculating shape data of a shape and size of a zoomed-in image area, in which a zoomed-in image is displayed, according to shape data of a shape and size of the image zoomed-in area, a step of determining an arranging position of the zoomed-in image area in the image screen, a step of recognizing a remained area which is obtained by removing the zoomed-in image area from the image screen, a step of displaying a zoomed-in image, which is obtained by zooming in an image of the image zoomed-in area according to the zooming-in processing, in the zoomed-in image area, and a step of displaying no image in the remained area.

Therefore, the displaying processing for images of the remained area, for which no user carefully pay attention, can be omitted. Accordingly, the image display of the zoomed-in image can be performed at high speed when the image zooming-in processing is performed to obtain the zoomed-in image.

The main object is also achieved by the provision of an image displaying method comprising a step of specifying an image zoomed-in area of an image screen in which an image planned to be zoomed in according to a zooming-in processing is displayed, a step of calculating shape data of a shape and size of a zoomed-in image area, in which a zoomed-in image is displayed, according to shape data of a shape and size of the image zoomed-in area, a step of determining an arranging position of the zoomed-in image area in the image screen, a step of recognizing a remained area which is obtained by removing the zoomed-in image area from the image screen, a step of predicting a processing time required to display an image of an object existing in the remained area in the remained area for each object of the remained area, a step of determining no display of the image of the object of which the processing time is longer than a prescribed processing time, a step of displaying a zoomed-in image, which is obtained by zooming in an image of the image zoomed-in area according to the zooming-in processing, in the zoomed-in image area, a step of setting a part of the remained area relating to the object, for which no display of the image is determined, as a non-display region a step of displaying no image in the non-display region of the remained area, and a step of displaying an image of an object, which exists in the other part of the remained area other than the non-display region, in the other part of the remained area.

Therefore, in cases where it is predicted that a long processing time is required to display an image of the non-display object in the remained area not carefully receiving attention from users, the image displaying processing for the non-display object can be omitted. Accordingly, when a displayed image is changed to another image in a normal operation, the changed image can be displayed at high speed.

The main object is also achieved by the provision of an image displaying method comprising a step of specifying an image zoomed-in area of an image screen in which an image planned to be zoomed in according to a zooming-in processing is displayed, a step of calculating shape data of a shape and size of a zoomed-in image area, in which a zoomed-in image is displayed, according to shape data of a shape and size of the image zoomed-in area, a step of determining an arranging position of the zoomed-in image area in the image screen, a step of recognizing a remained area which is obtained by removing the zoomed-in image area from the image screen, a step of measuring an information volume of an image of an object existing in the remained area for each object of the remained area, a step of determining no display of the image of the object of which the information volume is larger than a prescribed information volume, a step of displaying a zoomed-in image, which is obtained by zooming in an image of the image zoomed-in area according to the zooming-in processing, in the zoomed-in image area, a step of setting a part of the remained area relating to the object, for which no display of the image is determined, as a non-display region, a step of displaying no image in the non-display region of the remained area, and a step of displaying an image of an object, which exists in the other part of the remained area, in the other part of the remained area.

Therefore, the image displaying processing for the non-display object, of which the information volume in the remained area not carefully receiving attention from users is large, can be omitted.

Accordingly, the image display of the zoomed-in image can be performed at high speed when the image zooming-in processing is performed to obtain the zoomed-in image.

The subordinate object is achieved by the provision of an image displaying method comprising a step of specifying a display simplifying area of an image screen in which images processed according to a display simplifying processing are displayed, a step of recognizing a normal display region which is obtained by removing the display simplifying area from the image screen, a step of predicting a processing time required to display an image of an object existing in the display simplifying area in the display simplifying area for each object of the display simplifying area, a step of determining no display of the image of the object of which the processing time is longer than a prescribed processing time, a step of setting a part of the display simplifying area relating to the object, for which no display of the image is determined, as a non-display region, a step of displaying no image in the non-display region of the display simplifying area, a step of displaying an image of an object, which exists in the other part of the display simplifying area, in the other part of the display simplifying area, and a step of displaying an image of an object, which exists in the normal display region, in the normal display region.

Therefore, in cases where it is predicted that a long processing time is required to display an image of the non-display object in the display simplifying area not carefully receiving attention from users, the image displaying processing for the non-display object can be omitted. Accordingly, when a displayed image is changed to another image in a normal operation, the changed image can be displayed at high speed.

The subordinate object is also achieved by the provision of an image displaying method comprising a step of specifying a display simplifying area of an image screen in which images processed according to a display simplifying processing are displayed, a step of recognizing a normal display region which is obtained by removing the display simplifying area from the image screen, a step of measuring an information volume of an image of an object existing in the display simplifying area for each object of the display simplifying area, a step of determining no display of the image of the object of which the information volume is larger than a prescribed information volume, a step of setting a part of the display simplifying area relating to the object, for which no display of the image is determined, as a non-display region, a step of displaying no image in the non-display region of the display simplifying area, a step of displaying an image of an object, which exists in the other part of the display simplifying area, in the other part of the display simplifying area, and a step of displaying an image of an object, which exists in the normal display region, in the normal display region.

Therefore, the image displaying processing for the non-display object, of which the information volume in case of the display in the display simplifying area not carefully receiving attention from users is large, can be omitted.

Accordingly, when a displayed image is changed to another image in a normal operation, the changed image can be displayed at high speed.

### BRIEF DESCRIPTION OF THE DRAWINGS

FIG. 1 is a view showing the configuration of an image displaying device in which an image displaying method is performed according to a first embodiment of the present invention;

FIG. 2 is a flow chart showing the image display method according to the first embodiment of the present invention;

FIG. 3 is a view showing a change of a displayed image in cases where the image zooming-in processing is performed for the displayed image according to the image display method of the first embodiment;

FIG. 4 is a view showing a change of a displayed image in cases where the displayed image is zoomed in according to the image zooming-in processing of an image display method of a first modification of the first embodiment;

FIG. 5 is a view showing a change of a displayed image in cases where the displayed image is zoomed in according to the image zooming-in processing of an image display method of a second modification of the first embodiment;

FIG. 6 is a flow chart showing an image display method according to the second embodiment of the present invention;

FIG. 7 is a flow chart showing an image display method according to the third embodiment of the present invention;

FIG. 8 is a flow chart showing an image display method according to a fourth embodiment of the present invention;

FIG. 9 is a view showing a change of a displayed image in cases where the image simplifying processing is performed for the displayed image according to the image display method of the fourth embodiment;

FIG. 10 is a flow chart showing an image display method according to the fifth embodiment of the present invention; and

FIG. 11 is a view showing a change of a displayed image in cases where the image zooming-in processing is performed for the displayed image according to a conventional image displaying method.

### DETAILED DESCRIPTION OF THE PREFERRED EMBODIMENTS

Embodiments of the present invention will now be described with reference to the accompanying drawings.

Embodiment 1

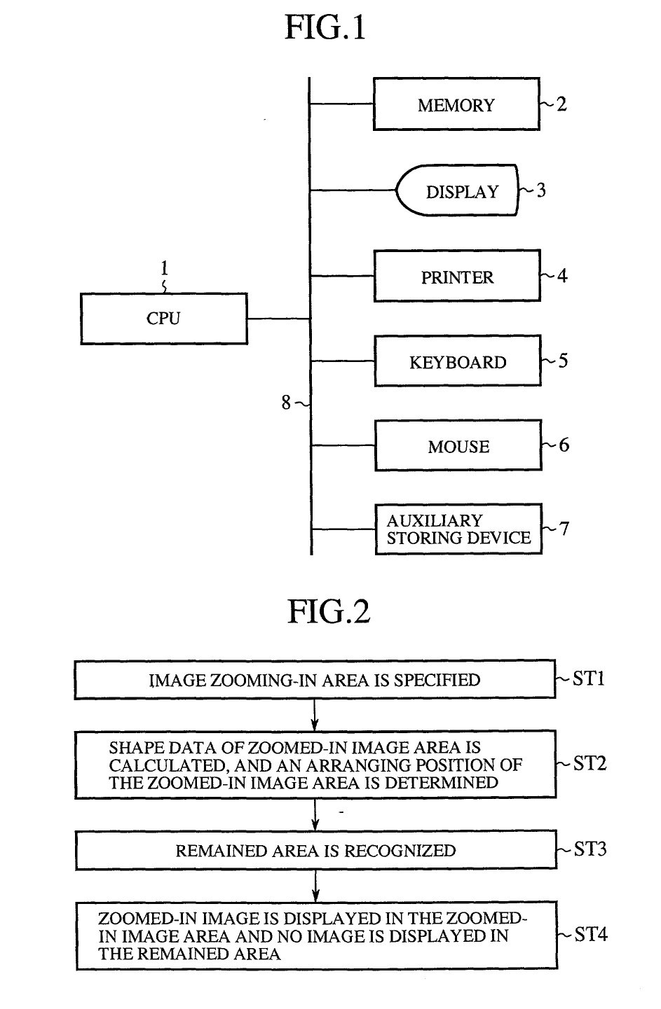

FIG. 1 is a view showing the configuration of an image displaying device in which an image displaying method is performed according to a first embodiment of the present invention. In FIG. 1, 1 indicates a central processing unit (CPU) for performing the calculation and control in an image zooming-in operation or a display simplifying operation according to prescribed graphic data processing programs. 2 indicates a memory for storing data and programs. 3 indicates a display denoting an image displaying device for displaying drawings, documents and programs prepared in the CPU 1. 4 indicates a printer for outputting the drawings, the documents and the programs prepared in the CPU 1 to a paper. 5 indicates a keyboard used to input commands and data relating to the graphic data processing. 6 indicates a mouse for designating a position of an area placed on an image screen of the display 3 to select an item from a menu or to extract a figure element. 7 indicates an auxiliary storing device such as a floppy disk or a hard disk for storing data and programs relating to drawings prepared in the CPU 1. 8 indicates a data bus through which data is transmitted among the CPU 1, the memory 2, the display 3, the printer 4, the keyboard 5, the mouse 6 and the auxiliary storing device 7. It is preferred that a private graphic card having a graphic data processing function is attached to an input terminal of the display 3 to reduce a load of the CPU 1.

Next, an operation of the image displaying device performed according to the image displaying method will be described below.

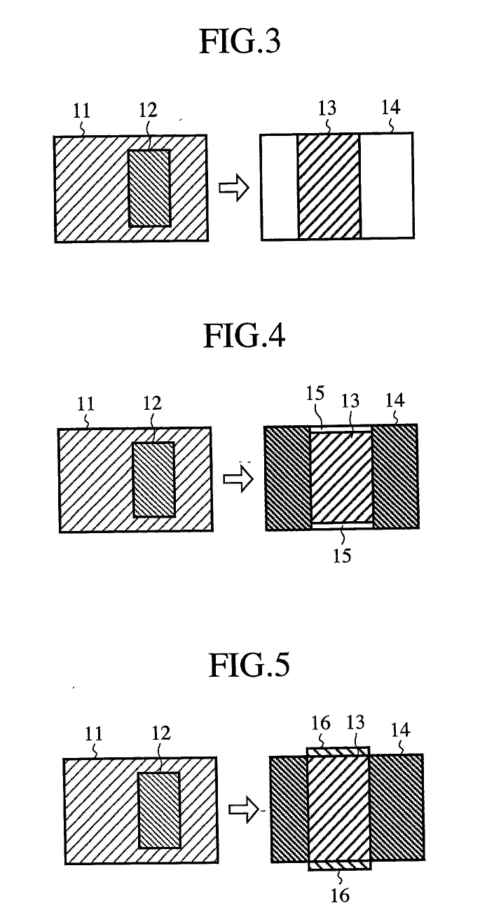

FIG. 2 is a flow chart showing an image display method according to the first embodiment of the present invention. FIG. 3 is a view showing a change of a displayed image in cases where the image zooming-in processing is performed for the displayed image according to the image display method of the first embodiment.

In FIG. 3, 11 indicates a whole image screen of the display 3. An image or a plurality of images are displayed on the whole image screen 11. 12 indicates an image zoomed-in area in which a displayed image planned to be zoomed in is arranged. 13 indicates a zoomed-in image area in which a displayed image zoomed in by the image zooming-in processing is arranged. 14 indicates a remained area. An area of the whole image screen 11 is composed of the zoomed-in image area 13 and the remained area 14.

For example, a drawing is prepared in the CPU 1 by using a graphic data program loaded from the auxiliary storing device 7 to the memory 2, a plurality of images of objects of the drawing are displayed on the whole image screen 11 of the display 3, and an image of objects (or an object) displayed in the image zoomed-in area 12 is zoomed in by the image zooming-in processing. In this image zooming-in processing, to specify the image zoomed-in area 12, a user specifies a surrounding line of the image zoomed-in area 12 by using the mouse 6 or inputs coordinate values of the image zoomed-in area 12 by using the keyboard 5, or a user specifies the image zoomed-in area 12 according to a result of the calculation based on a graphic data processing program which is used to extract an area relating to the image zooming-in processing (step ST1).

Thereafter, when the user inputs a command relating to the image zooming-in processing by using the mouse 6 or the keyboard 5, shape data indicating a shape and size of the zoomed-in image area 13 is calculated in the CPU 1 according to shape data indicating a shape and size of the image zoomed-in area 12, and an arranging position of the zoomed-in image area 13 in the whole image screen 11 is determined (step ST2). Also, the remained area 14, which is obtained by removing the zoomed-in image area 13 from the whole image screen 11, is recognized in the CPU 1 (step ST3). Therefore, the zoomed-in image area 13 and the remained area 14 are distinguished from each other in the CPU 1.

Thereafter, a prescribed image processing calculation is performed for values of pixels composing the image of objects (or an object) of the image zoomed-in area 12 in the CPU 1 to obtain a zoomed-in image, the zoomed-in image of the objects is displayed in the zoomed-in image area 13, and no image of objects existing in the remained area 14 is displayed in the remained area 14 (step ST4). That is, pieces of luminance data of pixels of the remained area 14 recognized in the CPU 1 are set to the same constant value. For example, it is preferred that the pieces of luminance data are set to zero.-Thereafter, a display operation is performed for the remained area 14 to substantially display no image in the remained area 14.

In this embodiment, the luminance data relating to the remained area 14 are set to the same constant value and are output to the display 3. However, it is applicable that no luminance data relating to the remained area 14 be output to the display 3.

Also, in this embodiment, the image zooming-in processing of the steps ST1 to ST4 is performed by executing the programs stored in the memory 2 under the control of the CPU 1. However, it is applicable that one or more steps of the image zooming-in processing be performed by using a specialized hard ware.

Also, in this embodiment, the zoomed-in image area 13 shown in FIG. 3 is obtained by zooming in the image zoomed-in area 12 at a maximum zooming-in rate on condition that the whole image displayed in the image zoomed-in area 12 is displayed in the whole image screen 11. However, the first embodiment is not limited to the maximum zooming-in rate.

FIG. 4 is a view showing a change of a displayed image in cases where the displayed image is zoomed in according to the image zooming-in processing of an image display method of a first modification of the first embodiment, and FIG. 5 is a view showing a change of a displayed image in cases where the displayed image is zoomed in according to the image zooming-in processing of an image display method of a second modification of the first embodiment.

In the first modification of the first embodiment shown in FIG. 4, the zoomed-in image area 13 is obtained by zooming in the image zoomed-in area 12 at a zooming-in rate lower than the maximum zooming-in rate. Therefore, two dead areas 15 are formed on the upper and lower sides of the zoomed-in image area 13 respectively. In this case, it is preferred that no image is displayed in each of the dead areas 15.

Also, in the second modification of the first embodiment shown in FIG. 5, the zoomed-in image area 13 is obtained by zooming in the image zoomed-in area 12 at a zooming-in rate higher than the maximum zooming-in rate. Therefore, the upper and lower end portions of the zoomed-in image area 13 are extruded from the whole image screen 11, and two out-of-image screen areas 16 extruded from the whole image screen 11 are formed in the upper and lower end portions of the zoomed-in image area 13 respectively. In this case, a part of the zoomed-in image placed in each out-of-image screen area 16 is not displayed on the whole image screen 11.

As is described above, in the first embodiment, the image zoomed-in area 12 is specified in the step ST1, shape data of the zoomed-in image area 13 is calculated according to shape data of the image zoomed-in area 12 in the step ST2, an arranging position of the zoomed-in image area 13 in the whole image screen 11 is determined in the step ST2, the remained area 14, which is obtained by removing the zoomed-in image area 13 from the whole image screen 11, is recognized in the step ST3, an image of objects of the image zoomed-in area 12 is zoomed in to display the zoomed-in image of the objects in the zoomed-in image area 13 in the step ST4, and no image of objects existing in the remained area 14 is displayed in the remained area 14 in the step ST4. Therefore, the displaying processing for images of the remained area 14, for which no user carefully pay attention, can be omitted. Accordingly, the image display of the zoomed-in image can be performed at high speed when the image zooming-in processing is performed to obtain the zoomed-in image.

Embodiment 2

In an image displaying method according to a second embodiment of the present invention, a processing time required for the display of an image of each object existing in the remained area 14 is predicted in the CPU 1, and the image of the object is not displayed in the remained area 14 in cases where the processing time required for the display of the image of the object is longer than a prescribed time period.

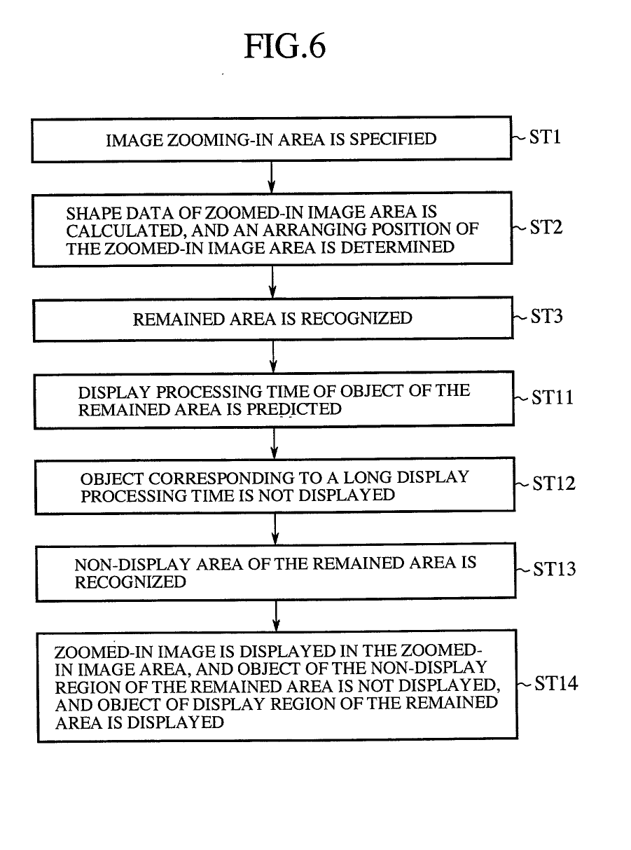

FIG. 6 is a flow chart showing an image display method according to the second embodiment of the present invention. The operation of the image displaying device in the steps ST1 to ST3 is the same as that according to the first embodiment. Therefore, an additional description relating to the steps ST1 to ST3 is omitted.

After the zoomed-in image area 13 and the remained area 14 are distinguished from each other in the step ST3, an object or a plurality of objects existing in the remained area 14 are detected, and a processing time required for the display of an image of each object existing in the remained area 14 is predicted (step ST11). In detail, in the prediction of the processing time required for the display of an image of each object, a structure of pieces of data expressing the object is, for example, examined to recognize a type of constituent element (for example, a free-form curve or a free-form surface) of the object, and the processing time required for the display of the image of the object is predicted according to the type of constituent element of the object. Also, the processing time required for the display of the image of the object is predicted according to a size of the image of the object presumed to be displayed in the remained area 14. Also, in cases where the image zooming-in processing is performed for each object existing in the remained area 14, the processing time required for the display of the image of the object is predicted according to the difference in shape data between a non-zoomed-in image of the object obtained before the image zooming-in processing and a zoomed-in image of the object obtained after the image zooming-in processing.

Thereafter, it is judged whether or not the processing time required for the display of the image of the object is longer than a prescribed threshold time period. In cases where the processing time required for the display of the image of the object is longer than the prescribed threshold time period, it is determined that the image of the object is not displayed in the remained area 14 (step ST12). In this case, it is preferred that a flag indicating the display or no display is attached to each object to add the flag to data of the object as attribute data. Therefore, it is easy to recognize the display or no display of an image of an arbitrary object by referring the flag attached to the arbitrary object. In this specification, the object, for which no display in the remained area 14 is determined, is called a non-display object.

Thereafter, a part of the remained area 14 occupied by each non-display object is recognized (step ST13). In this case, pieces of luminance data of pixels expressing an image of the non-display object are set to the same constant value. For example, it is preferred that the pieces of luminance data are set to zero. Also, it is preferred that the pieces of luminance data are set to a prescribed constant value indicating no display. In this specification, parts of the remained area 14 occupied by all non-display objects are called a non-display region, and the other parts of the remained area 14 not occupied by any non-display object are called a display region.

After the non-display region and the display region in the remained area 14 are distinguished from each other, a prescribed image processing calculation is performed for values of pixels composing the image of the image zoomed-in area 12 to obtain a zoomed-in image, and the zoomed-in image is displayed in the zoomed-in image area 13 in the same manner as in the first embodiment (step ST14). Also, no display of images of objects placed in the non-display region of the remained area 14 is performed, and images of objects placed in the display region of the remained area 14 are displayed in the display region of the remained area 14 (step ST14).

As is described above, in the second embodiment, the image zoomed-in area 12 is specified in the step ST1, shape data of the zoomed-in image area 13 is calculated according to shape data of the image zoomed-in area 12 in the step ST2, an arranging position of the zoomed-in image area 13 in the whole image screen 11 is determined in the step ST2, the remained area 14 is recognized in the step ST3, a processing time required for the display of an image of each object existing in the remained area 14 is predicted in the step ST11, no display of an image of an object existing in a region (that is, a non-display region) of the remained area 14 is determined in the step ST12 in cases where the display processing time of the image of the object is longer than a prescribed threshold time period, an image of objects of the image zoomed-in area 12 is zoomed in to display the zoomed-in image of the objects in the zoomed-in image area 13 in the step ST14, no image of the object existing in the non-display region of the remained area 14 is displayed in the remained area 14 in the step ST14, and images of objects existing in a display region of the remained area 14 are displayed in the display region of the remained area 14.

Therefore, in cases where it is predicted that a long processing time is required to display an image of the non-display object in the remained area 14 not carefully receiving attention from users, the image displaying processing for the non-display object can be omitted. Accordingly, the image display of a zoomed-in image can be performed at high speed when the image zooming-in processing is performed to obtain the zoomed-in image.

Embodiment 3

In an image displaying method according to a third embodiment of the present invention, an information volume of an image of each object existing in the remained area 14 is measured, and an image of an object, of which the information volume is larger than a prescribed information volume, is not displayed in the remained area 14.

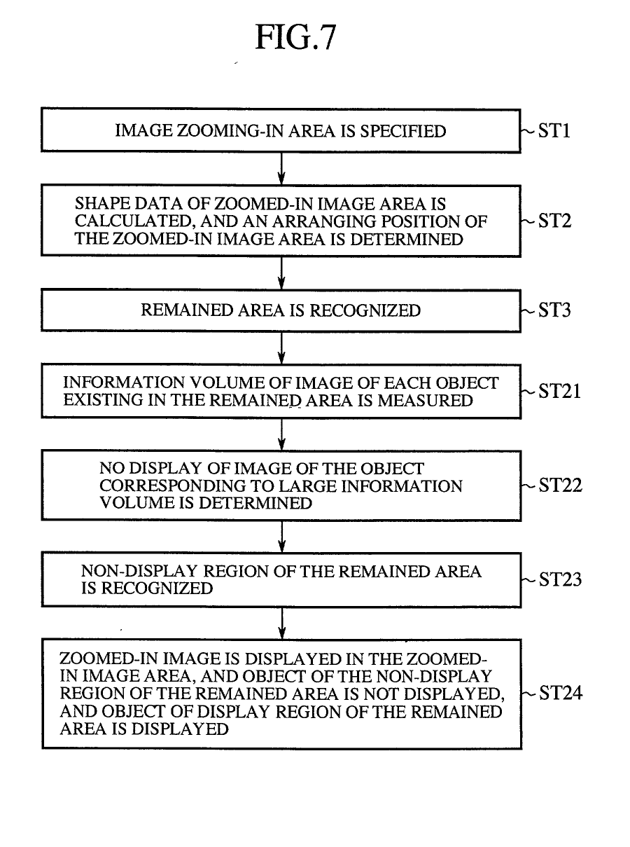

FIG. 7 is a flow chart showing an image display method according to the third embodiment of the present invention. The operation of the image displaying device in the steps ST1 to ST3 is the same as that according to the first embodiment. Therefore, an additional description relating to the steps ST1 to ST3 is omitted.

After the zoomed-in image area 13 and the remained area 14 are distinguished from each other in the step ST3, an object or a plurality of objects existing in the remained area 14 are detected, and an information volume of an image of each object presumed to be displayed in the remained area 14 is measured (step ST21). In detail, in the measurement of the information volume relating to an image of each object, the number of pixels relating to an image of the object presumed to be displayed in the remained area 14 is measured as an information volume of the image of the object, or a size of the image of the object is measured as an information volume of the image of the object. Also, in cases where the image zooming-in processing is performed for each object existing in the remained area 14, the difference between the number of pixels relating to a non-zoomed-in image of the object obtained before the image zooming-in processing and the number of pixels relating to a zoomed-in image of the object obtained after the image zooming-in processing is measured as an information volume of the image of the object.

Thereafter, it is judged whether or not the information volume of the image of the object is larger than a prescribed threshold value. In cases where the information volume of the image of the object is higher than the prescribed threshold value, it is determined that the image of the object is not displayed in the remained area 14 (step ST22). In this case, it is preferred that a flag indicating the display or no display is attached to each object to add the flag to data of the object as attribute data. Therefore, it is easy to recognize whether or not an arbitrary object existing in the remained area 14 is a non-display object or a display object by referring the flag attached to the arbitrary object.

Thereafter, a part of the remained area 14 occupied by each non-display object is recognized (step ST23). In this case, pieces of luminance data of pixels expressing an image of the non-display object are set to the same constant value. For example, it is preferred that the pieces of luminance data are set to zero. Also, it is preferred that the pieces of luminance data are set to a prescribed constant value indicating no display.

After the non-display region and the display region in the remained area 14 are distinguished from each other, a prescribed image processing calculation is performed for values of pixels composing the image of the image zoomed-in area 12 to obtain a zoomed-in image, and the zoomed-in image is displayed in the zoomed-in image area 13 in the same manner as in the first embodiment (step ST24). Also, no display of objects placed in the non-display region of the remained area 14 is performed, and images of objects placed in the display region of the remained area 14 are displayed in the display region of the remained area 14 (step ST24).

As is described above, in the third embodiment, the image zoomed-in area 12 is specified in the step ST1, shape data of the zoomed-in image area 13 is calculated according to shape data of the image zoomed-in area 12 in the step ST2, an arranging position of the zoomed-in image area 13 in the whole image screen 11 is determined in the step ST2, the remained area 14 is recognized in the step ST3, an information volume of an image of each object existing in the remained area 14 is measured in the step ST21, no display of an image of an object existing in a region (that is, a non-display region) of the remained area 14 is determined in the step ST22 in cases where the information volume of the image of the object in the remained area 14 is larger than a prescribed threshold value, an image of an object of the image zoomed-in area 12 is zoomed in to display the zoomed-in image in the zoomed-in image area 13 in the step ST24, no image of the object existing in the non-display region of the remained area 14 is displayed in the remained area 14 in the step ST24, and images of objects existing in a display region of the remained area 14 are displayed in the display region of the remained area 24. Therefore, the image displaying processing for the non-display object, of which the information volume in the remained area 14 not carefully receiving attention from users is large,. can be omitted.

Accordingly, the image display of the zoomed-in image can be performed at high speed when the image zooming-in processing is performed to obtain the zoomed-in image.

Embodiment 4

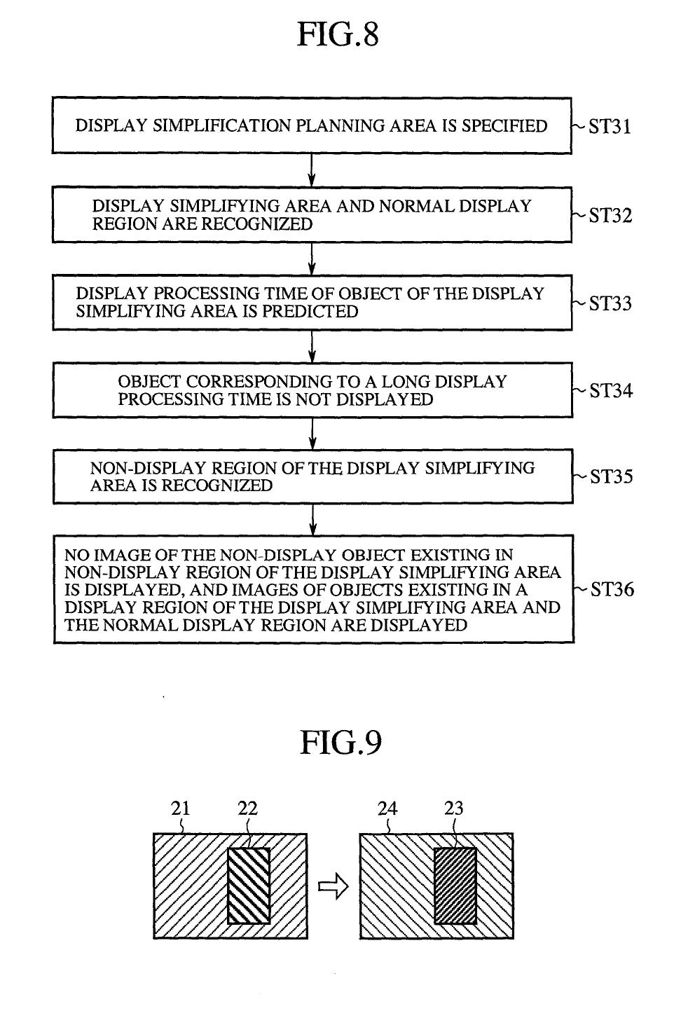

FIG. 8 is a flow chart showing an image display method according to a fourth embodiment of the present invention, and FIG. 9 is a view showing a change of a displayed image in cases where the image simplifying processing is performed for the displayed image according to the image display method of the fourth embodiment.

In FIG. 9, 21 indicates a whole image screen of the display 3. An image or a plurality of images are displayed on the whole image screen 21. 22 indicates a display simplification planning area in which an image or a plurality of images planned to be processed according to a display simplifying processing are arranged. 23 indicates a display simplifying area in which an image or a plurality of images processed according to the display simplifying processing are arranged. It is not required for users to carefully pay attention to images of the display simplifying area 23. 24 indicates a normal display region. An area of the whole image screen 21 is composed of the display simplifying area 23 and the normal display region 24.

Here, a position of the display simplification planning area 22 in the whole image screen 21 agrees with a position of the display simplifying area 23. However, because images displayed in the display simplification planning area 22 differ from those displayed in the display simplifying area 23, two names are used for the same area of the whole image screen 21. Also, because an image displaying device used for the image displaying method of the fourth embodiment is the same as that used for the image displaying method of the first embodiment, an additional description of the image displaying device is omitted.

For example, a drawing is prepared in the CPU 1 by using a graphic data program loaded from the auxiliary storing device 7 to the memory 2, a plurality of images of objects of the drawing are displayed on the whole image screen 21 of the display 3, the images displayed in the display simplification planning area 22 are simplified according to the display simplifying processing, and simplified images are displayed in the display simplifying area 23. In this display simplifying processing, to specify the display simplification planning area 22, a user specifies a surrounding line of the display simplification planning area 22 by using the mouse 6 or inputs coordinate values of the display simplification planning area 22 by using the keyboard 5, or a user specifies the display simplification planning area 22 according to a result of the calculation based on a graphic data processing program which is used to extract an area relating to the display simplifying processing (step ST31).

Thereafter, when the user inputs a command relating to the display simplifying processing by using the mouse 6 or the keyboard 5, the display simplifying area 23 and the normal display region 24, which is obtained by removing the display simplifying area 23 from the whole image screen 21, are recognized in the CPU 1 (step ST32).

After the display simplifying area 23 and the normal display region 24 are recognized and distinguished from each other in the step ST32, an object or a plurality of objects existing in the display simplifying area 23 are detected in the CPU 1, and a processing time required for the display of an image of each object existing in the display simplifying area 23 is predicted (step ST33). In detail, in the prediction of the processing time required for the display of an image of each object, a structure of pieces of data expressing the object is, for example, examined to recognize a type of constituent element (for example, a free-form curve or a free-form surface) of the object, and the processing time required for the display of the image of the object is predicted according to the type of constituent elements of the object. Also, the processing time required for the display of the image of the object is predicted according to a size of the image of the object presumed to be displayed in the display simplifying area 23.

Thereafter, it is judged whether or not the processing time required for the display of an image of each object existing in the display simplifying area 23 is longer than a prescribed threshold time period. In cases where the processing time required for the display of the image of the object is longer than the prescribed threshold time period, it is determined that the image of the object existing in the display simplifying area 23 is not displayed in the display simplifying area 23 (step ST34). In this case, it is preferred that a flag indicating the display or no display is attached to each object to add the flag to data of the object as attribute data. Therefore, it is easy to recognize the display or no display of an arbitrary object by referring the flag attached to the arbitrary object. In this specification, the object, for which no display in the display-simplifying area 23 is determined, is called a non-display object.

Thereafter, a part of the display simplifying area 23 occupied by each non-display object is recognized (step ST35). In this case, pieces of luminance data of pixels expressing an image of the non-display object are set to the same constant value. For example, it is preferred that the pieces of luminance data are set to zero. Also, it is preferred that the pieces of luminance data are set to a prescribed constant value indicating no display. In this specification, parts of the display simplifying area 23 occupied by all non-display objects are called a non-display region, and the other parts of the display simplifying area 23 not occupied by any non-display object are called a display region.

After the non-display region and the display region in the display simplifying area 23 are distinguished from each other, an image of each object existing in the non-display region of the display simplifying area 23 is not displayed in the display simplifying area 23, images of objects existing in the display region of the display simplifying area 23 are displayed in the display region of the display simplifying area 23, and images of objects existing in the normal display region 24 are displayed in the normal display region 24 without processing the objects (step ST36).

As is described above, in the fourth embodiment, the display simplification planning area 22 is specified in the step ST31, the display simplifying area 23 and the normal display region 24 are recognized in the step ST32, a processing time required for the display of an image of each object existing in the display simplifying area 23 is predicted in the step ST33, no display of an image of an object (or a non-display object), of which the display processing time is longer than a prescribed threshold time period, is determined in the step ST34, no image of the non-display object existing in a non-display region of the display simplifying area 23 is displayed in the non-display region of the display simplifying area 23 in the step ST36, images of objects existing in a display region of the display simplifying area 23 are displayed in the display region of the display simplifying area 23 in the step ST36, and images of objects existing in the normal display region 24 are displayed in the normal display region 24 in the step ST36.

Therefore, in cases where it is predicted that a long processing time is required to display an image of the non-display object in the display simplifying area 23 not carefully receiving attention from users, the image displaying processing for the non-display object can be omitted. Accordingly, when a displayed image is changed to another image in a normal operation, the changed image can be displayed at high speed.

Embodiment 5

In an image displaying method according to a fifth embodiment of the present invention, an information volume of an image of each object existing in the display simplifying area 23 is measured, and an image of an object, of which the information volume is larger than a prescribed information volume, is not displayed in the display simplifying area 23.

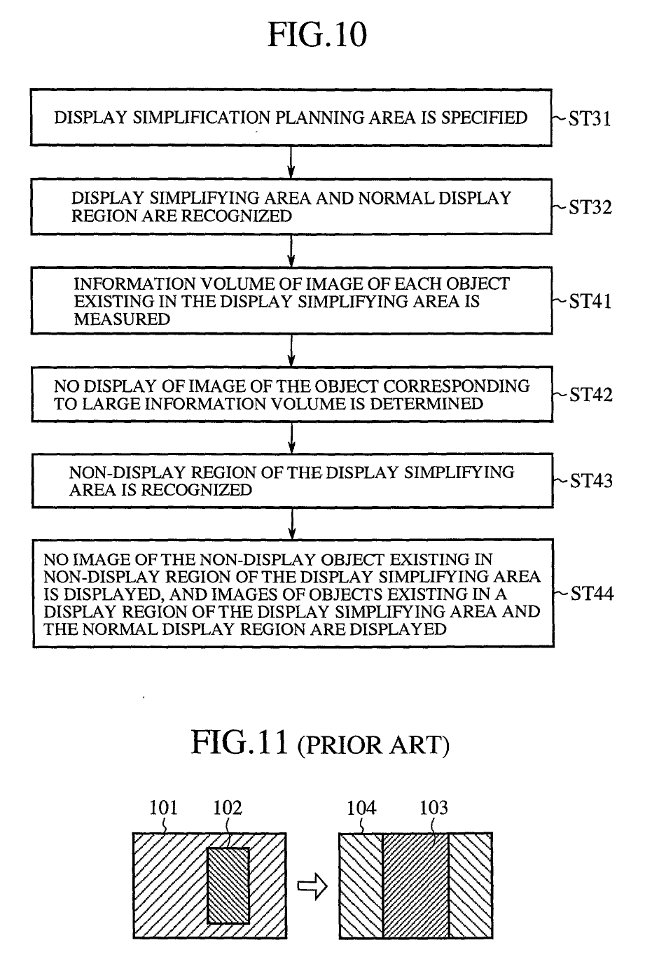

FIG. 10 is a flow chart showing an image display method according to the fifth embodiment of the present invention. The operation of the image displaying device in the steps ST31 and ST32 is the same as that according to the fourth embodiment. Therefore, an additional description relating to the steps ST31 and ST32 is omitted.

After the display simplifying area 23 and the normal display region 24 are distinguished from each other in the step ST32, an object or a plurality of objects existing in the display simplifying area 23 are detected in the CPU 1, and an information volume of an image of each object presumed to be displayed in the display simplifying area 23 is measured (step ST41). In detail, in the measurement of the information volume of an image of each object, the number of pixels relating to the image of the object presumed to be displayed in the display simplifying area 23 is measured as an information volume of the image of the object, or a size of the image of the object is measured as an information volume of the object.

Thereafter, it is judged whether or not the information volume of an image of each object existing in the display simplifying area 23 is larger than a prescribed threshold value. In cases where the information volume of the image of the object is higher than the prescribed threshold value, it is determined that the image of the object is not displayed in the display simplifying area 23 (step ST42). In this case, it is preferred that a flag indicating the display or no display is attached to each object to add the flag to data of the object as attribute data. Therefore, it is easy to recognize whether or not an arbitrary object existing in the display simplifying area 23 is a non-display object or a display object by referring the flag attached to the arbitrary object.

Thereafter, a part of the display simplifying area 23 occupied by each non-display object is recognized (step ST43). In this case, pieces of luminance data of pixels expressing an image of the non-display object are set to the same constant value. For example, it is preferred that the pieces of luminance data are set to zero. Also, it is preferred that the pieces of luminance data are set to a prescribed constant value indicating no display.

After the non-display region and the display region in the display simplifying area 23 are distinguished from each other, an image of each object existing in the non-display region of the display simplifying area 23 is not displayed, images of objects placed in the display region of the display simplifying area 23 are displayed in the display region of the display simplifying area 23, and images of objects existing in the normal display region 24 are displayed in the normal display region 24 without processing the objects (step ST44).

As is described above, in the fifth embodiment, the display simplification planning area 22 is specified in the step ST31, the display simplifying area 23 and the normal display region 24 are recognized in the step ST32, an information volume of an image of each object existing in the display simplifying area 23 is measured in the step ST41, no display of an image of an object (or a non-display object), of which the information volume in the display simplifying area 23 is larger than a prescribed threshold value, is determined in the step ST42, no image of the non-display object existing in a non-display region of the display simplifying area 23 is displayed in the non-display region of the display simplifying area 23 in the step ST44, images of objects existing in a display region of the display simplifying area 23 are displayed in the display region of the display simplifying area 23 in the step ST44, and images of objects existing in the normal display region 24 are displayed in the normal display region 24 in the step ST44.

Therefore, the image displaying processing for the non-display object, of which the information volume in the display simplifying area 23 not carefully receiving attention from users is large, can be omitted.

Accordingly, when a displayed image is changed to another image in a normal operation, the changed image can be displayed at high speed.

The image displaying method disclosed in each of the first to fifth embodiments is an example of the present invention, and a technical scope of the present invention is not limited by the embodiments. The technical scope of the present invention is designated by claims, and various technical ideas equivalent to the claims and various modifications in the claims are included in the technical scope of the present invention.

What is claimed is:

1. An image displaying method comprising the steps of:
specifying an image zoomed-in area of an image screen in which an image planned to be zoomed in according to a zooming-in processing is displayed;
calculating shape data of a shape and size of a zoomed-in image area, in which a zoomed-in image is displayed, according to shape data of a shape and size of the image zoomed-in area;
determining an arranging position of the zoomed-in image area in the image screen;
recognizing a remained area which is obtained by removing the zoomed-in image area from the image screen;
displaying a zoomed-in image, which is obtained by zooming in an image of the image zoomed-in area according to the zooming-in processing, in the zoomed-in image area; and
displaying no image in the remained area.

2. An image displaying method comprising the steps of:
specifying an image zoomed-in area of an image screen in which an image planned to be zoomed in according to a zooming-in processing is displayed;
calculating shape data of a shape and size of a zoomed-in image area, in which a zoomed-in image is displayed, according to shape data of a shape and size of the image zoomed-in area;
determining an arranging position of the zoomed-in image area in the image screen;
recognizing a remained area which is obtained by removing the zoomed-in image area from the image screen;
predicting a processing time required to display an image of an object existing in the remained area in the remained area for each object of the remained area;
determining no display of the image of the object of which the processing time is longer than a prescribed processing time;
displaying a zoomed-in image, which is obtained by zooming in an image of the image zoomed-in area according to the zooming-in processing, in the zoomed-in image area;
setting a part of the remained area relating to the object, for which no display of the image is determined, as a non-display region;
displaying no image in the non-display region of the remained area; and
displaying an image of an object, which exists in the other part of the remained area other than the non-display region, in the other part of the remained area.

3. An image displaying method comprising the steps of:
specifying an image zoomed-in area of an image screen in which an image planned to be zoomed in according to a zooming-in processing is displayed;
calculating shape data of a shape and size of a zoomed-in image area, in which a zoomed-in image is displayed, according to shape data of a shape and size of the image zoomed-in area;
determining an arranging position of the zoomed-in image area in the image screen;
recognizing a remained area which is obtained by removing the zoomed-in image area from the image screen;
measuring an information volume of an image of an object existing in the remained area for each object of the remained area;
determining no display of the image of the object of which the information volume is larger than a prescribed information volume;
displaying a zoomed-in image, which is obtained by zooming in an image of the image zoomed-in area according to the zooming-in processing, in the zoomed-in image area;
setting a part of the remained area relating to the object, for which no display of the image is determined, as a non-display region;
displaying no image in the non-display region of the remained area; and
displaying an image of an object, which exists in the other part of the remained area, in the other part of the remained area.

4. An image displaying method comprising the steps of:
specifying a display simplifying area of an image screen in which images processed according to a display simplifying processing are displayed;
recognizing a normal display region which is obtained by removing the display simplifying area from the image screen;
predicting a processing time required to display an image of an object existing in the display simplifying area in the display simplifying area for each object of the display simplifying area;
determining no display of the image of the object of which the processing time is longer than a prescribed processing time;
setting a part of the display simplifying area relating to the object, for which no display of the image is determined, as a non-display region;
displaying no image in the non-display region of the display simplifying area;
displaying an image of an object, which exists in the other part of the display simplifying area, in the other part of the display simplifying area; and
displaying an image of an object, which exists in the normal display region, in the normal display region.

5. An image displaying method comprising the steps of:
specifying a display simplifying area of an image screen in which images processed according to a display simplifying processing are displayed;
recognizing a normal display region which is obtained by removing the display simplifying area from the image screen;
measuring an information volume of an image of an object existing in the display simplifying area for each object of the display simplifying area;
determining no display of the image of the object of which the information volume is larger than a prescribed information volume;
setting a part of the display simplifying area relating to the object, for which no display of the image is determined, as a non-display region;
displaying no image in the non-display region of the display simplifying area;
displaying an image of an object, which exists in the other part of the display simplifying area, in the other part of the display simplifying area; and
displaying an image of an object, which exists in the normal display region, in the normal display region.
